(19) United States
(12) Patent Application Publication
(10) Pub. No.: US 2025/0142552 A1
(43) Pub. Date: May 1, 2025

(54) DYNAMIC DATA TRANSMISSION METHOD AND APPARATUS, AND STORAGE MEDIUM

(71) Applicant: DATANG MOBILE COMMUNICATIONS EQUIPMENT CO.,LTD., Beijing (CN)

(72) Inventors: Chen LUO, Beijing (CN); Jiaqing WANG, Beijing (CN); Meiying YANG, Beijing (CN); Yinghao ZHANG, Beijing (CN)

(21) Appl. No.: 18/681,838

(22) PCT Filed: Aug. 4, 2022
(86) PCT No.: PCT/CN2022/110145

§ 371 Date: Feb. 6, 2024

(30) Foreign Application Priority Data
Aug. 6, 2021 (CN) 202110904389.2

(51) Int. Cl. H04W 72/11; H04W 72/232

(52) U.S. Cl. CPC H04W 72/11; H04W 72/232

(57) ABSTRACT

Embodiments of the present disclosure provide a dynamic data transmission method and apparatus, and a storage medium. The method comprises: configuring, for a terminal, dynamic resource indication information associated with semi-persistent scheduling (SPS); and performing dynamic data transmission indication by using the dynamic resource indication information in a discontinuous reception off (DRX-off) period. According to the dynamic data transmission method and apparatus, and the storage medium provided in the embodiments of the present disclosure, during the DRX-off period, SPS PDSCH transmission is assisted by means of dynamic scheduling, and in the case that a data packet is relatively large but reserved SPS PDSCH resources are insufficient, the transmission of the data packet is assisted, without waiting for the next SPS PDSCH or a DRX-on period, thereby reducing the transmission delay.

### CROSS-REFERENCE TO RELATED APPLICATION

The present application is a National Stage of International Application No. PCT/CN2022/110145, filed on Aug. 4, 2022, which claims priority to Chinese patent application No. 202110904389.2 filed on Aug. 6, 2021, entitled “Dynamic Data Transmission Method and Apparatus, and Storage Medium”, which are hereby incorporated by reference in their entireties.

### FIELD

The present application relates to the field of communication, and in particular to dynamic data transmission methods and apparatuses, and a storage medium.

### BACKGROUND

With the continuous development and improvement of the 5th generation mobile communication (5G) technology, low-latency, high-bandwidth services and scenarios for consumers have become current focus. An extended reality (XR) service is one of them.

It is conducive to the periodicity of semi-persistent scheduling (SPS) because of quasi-periodic features of the XR service. On one hand, data may be transmitted on a pre-configured periodic physical downlink shared channel (PDSCH), and no scheduling request is needed. On the other hand, PDSCH transmission may be performed in SPS scheduling during a discontinuous reception (DRX)-off period. Therefore, SPS scheduling in the related art may be applied to XR service transmission.

However, XR service transmission using a traditional SPS scheduling has a problem of large transmission delay.

### SUMMARY

Embodiments of the present application provide dynamic data transmission methods and apparatuses and a storage medium, which solve a problem of large transmission delay in the related art.

An embodiment of the present application provides a dynamic data transmission method, applied to a network side device, including:
configuring dynamic resource indication information associated with semi-persistent scheduling (SPS) for a terminal; and
indicating dynamic data transmission by using the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the method further includes:
configuring monitoring position information for the DCI signaling for the terminal.

In an embodiment, the monitoring position information includes one or more of the following information:
monitoring position information semi-statically configured through higher layer signaling; and
monitoring position information dynamically adjusted based on first information.

In an embodiment, in case that the monitoring position information includes the monitoring position information configured semi-statically through the higher layer signaling, the configuring the monitoring position information for the DCI signaling for the terminal includes:
configuring a monitoring start time for the DCI signaling for the terminal; or,
configuring a monitoring start time and a duration of a monitoring window for the DCI signaling for the terminal; or,
configuring a monitoring start time and a monitoring end time of a monitoring window for the DCI signaling for the terminal.

In an embodiment, the duration is determined by one or more of the following:
carrying in L1 signaling;
carrying in a media access control (MAC) layer signaling;
carrying in higher layer signaling; and
a monitoring timer.

In an embodiment, the monitoring position information further includes one or more of the following information:
a time point associated with SPS; and
an independent time point.

In an embodiment, the time point associated with SPS is one or more of the following time points:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.

In an embodiment, a time unit of an offset value of the monitoring position information relative to the time point is a slot, a span, a symbol or millisecond.

In an embodiment, the method further includes:
transmitting a dynamic transmission indicator to the terminal, where the dynamic transmission indicator is configured for indicating the terminal that the network side device performs dynamic data transmission.

In an embodiment, the method further includes:
transmitting a stop indicator to the terminal, where the stop indicator is configured for indicating the terminal that the network side device stops dynamic data transmission.

In an embodiment, the stop indicator is carried through L1 signaling, media access control (MAC) control element (CE) signaling, a power saving signal or higher layer signaling.

An embodiment of the present application further provides a dynamic data transmission method, applied to a terminal, including:
determining dynamic resource indication information associated with semi-persistent scheduling (SPS) transmitted from a network side device; and
receiving dynamic data based on the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the method further includes:
determining monitoring position information for the DCI signaling.

In an embodiment, the determining the monitoring position information for the DCI signaling includes:
determining a monitoring start time for the DCI signaling; or,
determining a monitoring start time and a duration of a monitoring window for the DCI signaling; or,
determining a monitoring start time and a monitoring end time of a monitoring window for the DCI signaling.

In an embodiment, the method further includes:
receiving a stop indicator transmitted from the network side device, where the stop indicator is configured for indicating the terminal that the network side device stops dynamic data transmission.

An embodiment of the present application further provides a network side device, including a memory storing a computer program, a processor and a transceiver transmitting and receiving data under control of the processor,
where the computer program, when executed by the processor of the network side device, causes the network side device to perform the following operations of:
configuring dynamic resource indication information associated with semi-persistent scheduling (SPS) for a terminal; and
indicating dynamic data transmission by using the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the computer program, when executed by the processor of the network side device, causes the network side device to further perform the following configuring monitoring position information for the DCI signaling for the terminal.

In an embodiment, the monitoring position information includes one or more of the following information:
monitoring position information semi-statically configured through higher layer signaling; and
monitoring position information dynamically adjusted based on first information.

In an embodiment, in case that the monitoring position information includes the monitoring position information configured semi-statically through the higher layer signaling, the configuring the monitoring position information for the DCI signaling for the terminal includes:
configuring a monitoring start time for the DCI signaling for the terminal; or,
configuring a monitoring start time and a duration of a monitoring window for the DCI signaling for the terminal; or,
configuring a monitoring start time and a monitoring end time of a monitoring window for the DCI signaling for the terminal.

In an embodiment, the duration is determined by one or more of the following:
carrying in L1 signaling;
carrying in a media access control (MAC) layer signaling;
carrying in higher layer signaling; and
a monitoring timer.

In an embodiment, the monitoring position information further includes one or more of the following information:
a time point associated with SPS; and
an independent time point.

In an embodiment, the time point associated with SPS is one or more of the following time points:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.

In an embodiment, a time unit of an offset value of the monitoring position information relative to the time point is a slot, a span, a symbol or millisecond.

In an embodiment, the computer program, when executed by the processor of the network side device, causes the network side device to further perform the following operation of:
transmitting a dynamic transmission indicator to the terminal, where the dynamic transmission indicator is configured for indicating the terminal that the network side device performs dynamic data transmission.

In an embodiment, the computer program, when executed by the processor of the network side device, causes the network side device to further perform the following operation of:
transmitting a stop indicator to the terminal, where the stop indicator is configured for indicating the terminal that the network side device stops dynamic data transmission.

In an embodiment, the stop indicator is carried through L1 signaling, media access control (MAC) control element (CE) signaling, a power saving signal or higher layer signaling.

An embodiment of the present application further provides a terminal, including a memory storing a computer program, a processor and a transceiver transmitting and receiving data under control of the processor,
where the computer program, when executed by the processor of the terminal, causes the terminal to perform the following operations of:
determining dynamic resource indication information associated with semi-persistent scheduling (SPS) transmitted from a network side device; and
receiving dynamic data based on the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the computer program, when executed by the processor of the terminal, causes the terminal to further perform the following operation of:
determining monitoring position information for the DCI signaling.

In an embodiment, the determining the monitoring position information for the DCI signaling includes:
determining a monitoring start time for the DCI signaling; or,
determining a monitoring start time and a duration of a monitoring window for the DCI signaling; or,
determining a monitoring start time and a monitoring end time of a monitoring window for the DCI signaling.

In an embodiment, the computer program, when executed by the processor of the terminal, causes the terminal to further perform the following operation of:
receiving a stop indicator transmitted from the network side device, where the stop indicator is configured for indicating the terminal that the network side device stops dynamic data transmission.

An embodiment of the present application further provides a dynamic data transmission apparatus, including:
a configuring device, used for configuring dynamic resource indication information associated with semi-persistent scheduling (SPS) for a terminal; and
an indicating device, used for indicating dynamic data transmission by using the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the dynamic data transmission apparatus further includes a second configuring device,
where the second configuring device is configured for configuring monitoring position information for the DCI signaling for the terminal.

In an embodiment, the monitoring position information includes one or more of the following information:
monitoring position information semi-statically configured through higher layer signaling; and
monitoring position information dynamically adjusted based on first information.

In an embodiment, in case that the monitoring position information includes the monitoring position information configured semi-statically through the higher layer signaling, the second configuring device includes a first configuring sub-device, a second configuring sub-device and a third configuring sub-device,
where the first configuring sub-device is configured for configuring a monitoring start time for the DCI signaling for the terminal;
the second configuring sub-device is configured for configuring a monitoring start time and a duration of a monitoring window for the DCI signaling for the terminal; and
the third configuring sub-device is configured for configuring a monitoring start time and a monitoring end time of a monitoring window for the DCI signaling for the terminal.

In an embodiment, the duration is determined by one or more of the following:
carrying in L1 signaling;
carrying in a media access control (MAC) layer signaling;
carrying in higher layer signaling; and
a monitoring timer.

In an embodiment, the monitoring position information further includes one or more of the following information:
a time point associated with SPS; and
an independent time point.

In an embodiment, the time point associated with SPS is one or more of the following time points:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.

In an embodiment, a time unit of an offset value of the monitoring position information relative to the time point is a slot, a span, a symbol or millisecond.

In an embodiment, the dynamic data transmission apparatus further includes a first indicating device,
where the first indicating device is configured for transmitting a dynamic transmission indicator to the terminal, where the dynamic transmission indicator is configured for indicating the terminal that the network side device performs dynamic data transmission.

In an embodiment, the dynamic data transmission apparatus further includes a second indicating device,
where the second indicating device is configured for transmitting a stop indicator to the terminal, where the stop indicator is configured for indicating the terminal that the network side device stops dynamic data transmission.

In an embodiment, the stop indicator is carried through L1 signaling, media access control (MAC) control element (CE) signaling, a power saving signal or higher layer signaling.

An embodiment of the present application further provides a dynamic data transmission apparatus, including:
a determining device, used for determining dynamic resource indication information associated with semi-persistent scheduling (SPS) transmitted from a network side device; and
a receiving device, used for receiving dynamic data based on the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the dynamic data transmission apparatus further includes a second determining device,
where the second determining device is configured for determining monitoring position information for the DCI signaling.

In an embodiment, the second determining device includes a first determining sub-device, a second determining sub-device and a third determining sub-device,
where the first determining sub-device is configured for determining a monitoring start time for the DCI signaling;
the second determining sub-device is configured for determining a monitoring start time and a duration of a monitoring window for the DCI signaling; and
the third determining sub-device is configured for determining a monitoring start time and a monitoring end time of a monitoring window for the DCI signaling.

In an embodiment, the dynamic data transmission apparatus further includes a second receiving device,
where the second receiving device is configured for receiving a stop indicator transmitted from the network side device, where the stop indicator is configured for indicating the terminal that the network side device stops dynamic data transmission.

An embodiment of the present application provides a processor-readable storage medium storing a computer program that when executed by a processor, causes the processor to perform the steps of the dynamic data transmission method described above.

In the dynamic data transmission methods and apparatuses and the storage medium provided by the embodiments of the present application, SPS PDSCH transmission is assisted through dynamic scheduling within DRX off period to complete the transmission of data services with large differences in data size. In case that the data packet is large, and the reserved SPS PDSCH resources are insufficient, data packet transmission is assisted without waiting for the next SPS PDSCH or DRX on period. In case that the data packet is small, the periodicity of reserved SPS PDSCH resources and dynamic scheduling resources may be used to complete data transmission and the transmission delay is reduced.

### BRIEF DESCRIPTION OF THE DRAWINGS

In order to clearly illustrate the solutions disclosed in the embodiments of the present application, the drawings used in the descriptions of the embodiments are briefly described below. The drawings in the following description are only some embodiments of the present application.

FIG. 1 is a first schematic flowchart of a dynamic data transmission method according to an embodiment of the present application;

FIG. 2 is a first schematic diagram of a semi-persistent scheduling (SPS) physical downlink shared channel (PDSCH) enhancement scheme according to an embodiment of the present application;

FIG. 3 is a second schematic diagram of a semi-persistent scheduling (SPS) physical downlink shared channel (PDSCH) enhancement scheme according to an embodiment of the present application;

FIG. 4 is a third schematic diagram of a semi-persistent scheduling (SPS) physical downlink shared channel (PDSCH) enhancement scheme according to an embodiment of the present application;

FIG. 5 is a second schematic flowchart of a dynamic data transmission method according to an embodiment of the present application;

FIG. 6 is a schematic structural diagram of a network side device according to an embodiment of the present application;

FIG. 7 is a schematic structural diagram of a terminal according to an embodiment of the present application;

FIG. 8 is a first schematic structural diagram of a dynamic data transmission apparatus according to an embodiment of the present application; and

FIG. 9 is a second schematic structural diagram of a dynamic data transmission apparatus according to an embodiment of the present application.

### DETAILED DESCRIPTION

In order to illustrate the embodiments of the present application clearly, the solutions in the embodiments of the present application are clearly and completely described in the following in conjunction with the accompanying drawings in the present application. These embodiments are a part of the embodiments of the present application, and not all of the embodiments.

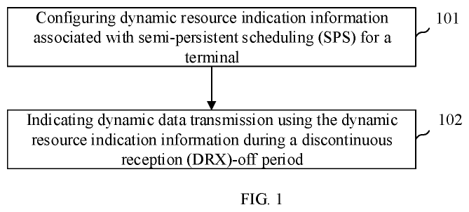

FIG. 1 is a first schematic flowchart of a dynamic data transmission method according to an embodiment of the present application. As shown in FIG. 1, the dynamic data transmission method according to an embodiment of the present application may be applied to a network side device, such as a base station, etc. The method includes the following steps.

Step 101: configuring dynamic resource indication information associated with semi-persistent scheduling (SPS) for a terminal.

In an embodiment, the network side device first configures the dynamic resource indication information associated with the SPS for the terminal.

The terminal determines the dynamic resource indication information associated with the SPS transmitted from the network side device.

For the dynamic resource indication information, it may be downlink control information (DCI) signaling associated with SPS, or it may be resource information (for example, a physical downlink shared channel (PDSCH) resource) carried by the DCI associated with the SPS. There may be one or multiple pieces of dynamic resource indication information associated with the SPS. The embodiments of the present application are described by taking one piece of dynamic resource indication information associated with the SPS as an example. The situation of multiple pieces of dynamic resource indication information associated with the SPS is similar thereto and is not described again here.

In an embodiment, the dynamic resource indication information is a DCI signaling associated with SPS, and resource allocation information is carried through the DCI signaling.

In an embodiment, the method further includes:
configuring, by the network side device, monitoring position information for the DCI signaling for the terminal.

In an embodiment, the monitoring position information includes one or more of the following information.

In one embodiment, monitoring position information semi-statically configured through higher layer signaling.

In an embodiment, in case that the monitoring position information includes the monitoring position information configured semi-statically through the higher layer signaling, the network side device configures the monitoring position information for the DCI signaling for the terminal by the following.

1. The network side device configures a monitoring start time for the DCI signaling for the terminal.

The monitoring start time includes one or more of the following information:
(1) a time point associated with SPS; and
(2) an independent time point.

2. The network side device configures a monitoring window for the DCI signaling for the terminal.

The network side device configures the monitoring window for the DCI signaling for the terminal by the following.

(1) The network side device configures a monitoring start time and a duration of the monitoring window for the DCI signaling for the terminal.

The monitoring start time includes one or more of the following information:
i. a time point associated with SPS; and
ii. an independent time point.

The duration of the monitoring window for the DCI signaling may be indicated explicitly or implicitly.

The duration of the monitoring window for the DCI signaling may be indicated explicitly by one or more of the following:
carrying the duration of the monitoring window for the DCI signaling in L1 signaling;
carrying the duration of the monitoring window for the DCI signaling in a media access control (MAC) layer signaling; and
carrying the duration of the monitoring window for the DCI signaling in higher layer signaling.

The duration of the monitoring window for the DCI signaling may be indicated implicitly by configuring a monitoring timer for the terminal, and the terminal may determine the duration of the monitoring window for the DCI signaling based on the monitoring timer.

(2) The network side device configures a monitoring start time and a monitoring end time of a monitoring window for the DCI signaling for the terminal.

The monitoring start time and/or the monitoring end time includes one or more of the following information:
i. a time point associated with SPS; and
ii. an independent time point.

In an embodiment, the monitoring position information further includes one or more of the following information.

1. A time point associated with SPS.

The time point associated with SPS may be a relative time point.

In an embodiment, the time point associated with SPS is one or more of the following time points.

(1) A time point associated with an SPS PDSCH

In an embodiment, the time point associated with SPS may be a time point associated with a start slot/an end slot/a start symbol/an end symbol of the SPS PDSCH.

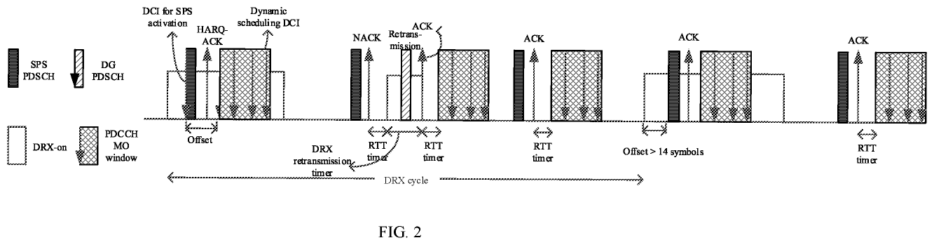

FIG. 2 is a first schematic diagram of an SPS PDSCH enhancement scheme according to an embodiment of the present application. As shown in FIG. 2, for example, at a time offset after the start slot of the SPS PDSCH, the DCI signaling starts to be monitored.

(2) A time point associated with a hybrid automatic repeat request (HARQ)-acknowledge (ACK) for the SPS PDSCH

In an embodiment, the time point associated with the HARQ-ACK for the SPS PDSCH may be a time point associated with a start slot/an end slot/a start symbol/an end symbol of the SPS PDSCH.

As shown in FIG. 2, for example, the DCI signaling starts to be monitored at a time offset after the end slot of the HARQ-ACK for the SPS PDSCH.

(3) A time point associated with expiring of an SPS PDSCH round trip time (RTT) timer

In an embodiment, the time point associated with expiring of the SPS PDSCH RTT timer may be a time point associated with a start slot/an end slot/a start symbol/an end symbol of the expiring of the SPS PDSCH RTT timer.

As shown in FIG. 2, for example, the DCI signaling starts to be monitored at a time offset after a start symbol of the expiring of the SPS PDSCH RTT timer.

In an embodiment, a time unit of an offset value of the monitoring position information relative to the time point may be a slot, a span, a symbol or millisecond.

In an embodiment, the time offset between the monitoring position information and the time point may be configured, and the time unit may be millisecond, a slot, or a symbol.

For example, the specific unit of the start time may be the start symbol of a slot, or a symbol position of a slot. The duration of the monitoring window may be several consecutive slots, or several consecutive symbols in a slot, or several fixed symbols in several consecutive slots. A length unit of the timer may be millisecond, slot, or symbol.

It should be noted that a value of the time offset between the start time and a time point associated with the start slot/end slot/start symbol/end symbol of SPS PDSCH or HARQ-ACK for the SPS PDSCH or expiring of the SPS PDSCH RTT timer may be greater than or equal to 0, that is, the above time point is the start time, or the start time is located at an offset time position subsequent to the above time point. The value of the time offset may be less than 0, that is, the start time is located at an offset time position ahead of the above time point.

In one embodiment, the value of the time offset between the start time and a time point associated with the start slot/end slot/start symbol/end symbol of SPS PDSCH or HARQ-ACK for the SPS PDSCH or expiring of the SPS PDSCH RTT timer may be greater than or equal to 0, but the start time point may be the above time point, or the start time point may be located at an offset time position subsequent to the above time point, or the start time point may be located at an offset time position ahead of the above time point.

2. An independent time point

The independent time point may be a specific time point, or a specific time point determined by the terminal through calculation. This independent time point may be independent of the SPS.

For example, the start time may be an absolute time, that is, a specific time calculated by the terminal based on a system frame number (SFN) through configuring a periodicity and an offset.

For example, a slot number of the start time satisfies the following conditions: (n_{f}. Nₛₗₒₜ^{frame,μ}+n_{s,f}^{μ}−oₛ)modkₛ=0,

where n_{f} is the frame number, n_{s,f}^{μ}, is a slot number per subcarrier μ, Nₛₗₒₜ^{frame,μ} is the number of slots included in a subframe per subcarrier μ, kₛ is the monitoring period, and oₛ is the offset value.

In another embodiment, monitoring position information dynamically adjusted based on first information.

The base station configures first information for the terminal to dynamically indicate changes in monitoring position information, for example, dynamically indicating one or more of a size of the monitoring window, the monitoring start position, and the monitoring end position.

For example, it indicates how long the terminal continues to monitor after dynamically scheduled DCI is monitored.

The first information may be carried in the L1 signaling, the MAC signaling or the higher layer signaling.

For example, the first information may be a monitoring timer or duration, or indication signaling information, or a reference signal. The monitoring timer is taken as an example, when the monitoring timer does not expire, the terminal may continue to perform service-specific DCI monitoring. When service data packet is transmitted at the end of the monitoring window due to delay jitter, the data packet needs to wait for a subsequent monitoring window or monitoring occasion to be transmitted. The configuration of the monitoring timer may help reduce the transmission delay caused by the delay jitter.

In an embodiment, the monitoring occasion (MO) for the DCI signaling may be one of the following.

(1) It may be configured through the configuration of a traditional search space set.

For example, the parameters, such as a monitoring periodicity and offset, a frequency domain aggregation level (AL), etc., are configured.

(2) It may be configured through associated configurations on a single MO (this may be at the slot level or span level).

(3) It may be associated with an index value of a search space.

In an embodiment, a time unit of the MO for DCI signaling may be a slot or a span, or the monitoring occasion may be configured by associating the index value of the search space.

Step 102: indicating dynamic data transmission by using the dynamic resource indication information during a discontinuous reception (DRX)-off period.

In an embodiment, after the network side device configures the dynamic resource indication information associated with the SPS for the terminal, the network side device indicates dynamic data transmission by using the dynamic resource indication information during the DRX-off period.

After the terminal determines the dynamic resource indication information associated with the SPS transmitted from the network side device, the terminal receives dynamic data based on the dynamic resource indication information during the DRX-off period.

In an embodiment, the method further includes the following steps.

The network side device transmits a dynamic transmission indicator to the terminal, where the dynamic transmission indicator is configured for indicating the terminal that the network side device performs dynamic data transmission.

The base station indicates the terminal to perform subsequent dynamic transmission indicators, indicating that the terminal may monitor the dynamically scheduled DCI after SPS PDSCH reception; otherwise, the terminal performs regular SPS PDSCH reception.

In an embodiment, the dynamic transmission indicator is indicated through L1 signaling, media access control (MAC) control element (CE) signaling, a power saving signal or higher layer signaling.

For example, in case that the terminal receives the following indications, and the base station configures monitoring position information for the dynamically scheduled DCI, it means that the terminal may monitor the dynamically scheduled DCI after the SPS PDSCH reception. Otherwise, the terminal performs regular SPS PDSCH reception. Specific indications include one or more of the following.

1. The terminal capability supports monitoring the dynamically scheduling DCI after the SPS PDSCH reception.

2. The terminal is indicated by scheduling DCI (such as: SPS PDSCH activation DCI, SPS PDSCH retransmission DCI, etc.).

3. The terminal is indicated by MAC CE to monitor the dynamically schedule DCI after subsequent SPS PDSCH reception.

4. The higher layer signaling is configured with a switch, indicating that monitoring dynamically scheduled DCI after the SPS PDSCH reception may be supported.

5. The terminal is indicated by the power saving signal to monitor the dynamically schedule DCI after subsequent SPS PDSCH reception.

It should be noted that the combination of several indications refers to the simultaneous presence of several of the above indications, for example: terminal capability and scheduling DCI indications, or terminal capability and switches configured by the higher layer signaling, etc., which are not described again here.

In an embodiment, in case that SPS PDSCH does not complete data transmission in a buffer of the network side device side, the network side device may indicate the terminal to monitor dynamically scheduled DCI after SPS PDSCH.

After the terminal receives the dynamic transmission indicator transmitted from the network side device, the terminal continues to monitor the dynamically scheduled DCI starting from the monitoring start position configured by the network side device and the granularity of monitoring is MO. That is, the terminal receives dynamic data based on the dynamic resource indication information during the DRX-off period.

In the dynamic data transmission method provided by the embodiments of the present application, SPS PDSCH transmission is assisted through dynamic scheduling within DRX off period to complete the transmission of data services with large differences in data size. In case that the data packet is large, and the reserved SPS PDSCH resources are insufficient, data packet transmission is assisted without waiting for the next SPS PDSCH or DRX on period. In case that the data packet is small, the periodicity of reserved SPS PDSCH resources and dynamic scheduling resources may be used to complete data transmission and the transmission delay is reduced.

In an embodiment, the method further includes the following step:
transmitting a stop indicator to the terminal, where the stop indicator is configured for indicating the terminal that the network side device stops dynamic data transmission.

In an embodiment, in case that a specific condition is met or the base station transmits an indication, the terminal stops monitoring the DCI in the monitoring window for the dynamically scheduled DCI.

For example, in case that the terminal completes data packet transmission, in order to avoid unnecessary DCI monitoring, the base station indicates the terminal to stop monitoring DCI in the monitoring window for the dynamically scheduled DCI.

In an embodiment, the stop indicator is carried through L1 signaling, media access control (MAC) control element (CE) signaling, a power saving signal or higher layer signaling.

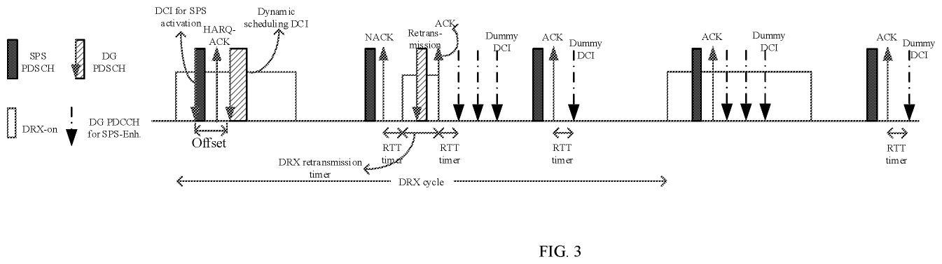

FIG. 3 is a second schematic diagram of a semi-persistent scheduling (SPS) physical downlink shared channel (PDSCH) enhancement scheme according to an embodiment of the present application. As shown in FIG. 3, for example, in case that a specific condition is met or the base station transmits an indication, the terminal is indicated to stop monitoring the DCI in the monitoring window for the dynamically scheduled DCI. It may be any one or a combination of the following conditions.

1. The terminal receives the scheduled DCI whose scheduling information is dummy.

2. The terminal stops monitoring the DCI in case that a configured timer expires. The configured timer is independent of the monitoring window.

3. The terminal receives SPS PDSCH release DCI.

It should be noted that the combination here refers to the simultaneous presence of the above-mentioned indications. If any one of them is met, monitoring the dynamically scheduled DCI may be stopped.

For example, in case that a monitoring timer and the scheduled DCI whose scheduling information is dummy are configured at the same time, either one of above conditions is met, monitoring the dynamically scheduled DCI may be stopped, which is not described again here.

In the embodiment of the present application, stopping monitoring the DCI may mean that the terminal skips monitoring, or the terminal enters sleep.

By the dynamic data transmission method provided by the embodiments of the present application, monitoring the dynamically scheduled DCI is stopped when specific conditions are met, which may reduce signaling overhead and improve frequency spectrum utilization.

In an embodiment, whether to monitor the dynamically scheduled DCI may be indicated by a monitoring window and/or a monitoring start position for the dynamically scheduled DCI carried in a power saving signal, such as DCI format 2_6 or non-scheduled DCI or MAC CE.

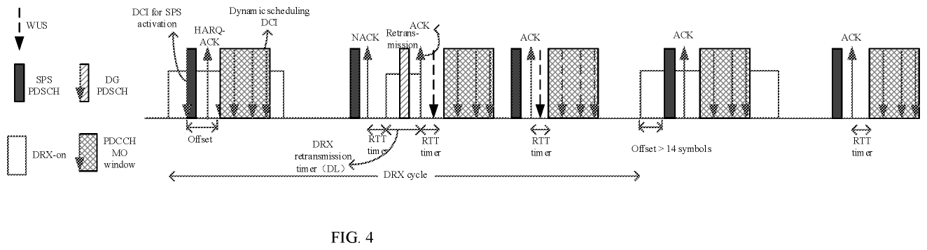

FIG. 4 is a third schematic diagram of a semi-persistent scheduling (SPS) physical downlink shared channel (PDSCH) enhancement scheme according to an embodiment of the present application. As shown in FIG. 4, for the case where DCI format 2_6 carries the monitoring window and/or monitoring start position for the dynamically scheduled DCI, it means that one or more monitoring occasions may be configured during the DRX-off period to indicate whether to monitor the dynamically scheduled DCI after one or more subsequent SPS PDSCHs. The monitoring position for the DCI format 2_6 may be transmitted after the SPS PDSCH.

In one embodiment, taking the start time ahead of the reference time point as an example, in case that the terminal monitors the dynamically scheduled DCI before SPS PDSCH, the terminal may perform one of the following operations.

1. If the PDSCH indicated by the dynamically scheduled DCI is located behind the SPS PDSCH, the terminal may receive dynamically scheduled data information based on the PDSCH indicated by the dynamically scheduled DCI after the SPS PDSCH or the HARQ-ACK for the SPS PDSCH or the expiring of the SPS PDSCH RTT timer.

2. If the PDSCH indicated by the dynamically scheduled DCI is located ahead of the SPS PDSCH, or overlaps with the SPS PDSCH slot, the terminal may receive dynamically scheduled data information based on the PDSCH indicated by the dynamically scheduled DCI without performing the SPS PDSCH reception or the terminal may receive non-overlapping PDSCH based on the SPS PDSCH.

The above reference time point may be a time point associated with a start slot/an end slot/a start symbol/an end symbol of the SPS PDSCH, a time point associated with a start slot/an end slot/a start symbol/an end symbol of the SPS PDSCH, a time point associated with a start slot/an end slot/a start symbol/an end symbol of the expiring of the SPS PDSCH RTT timer, etc.

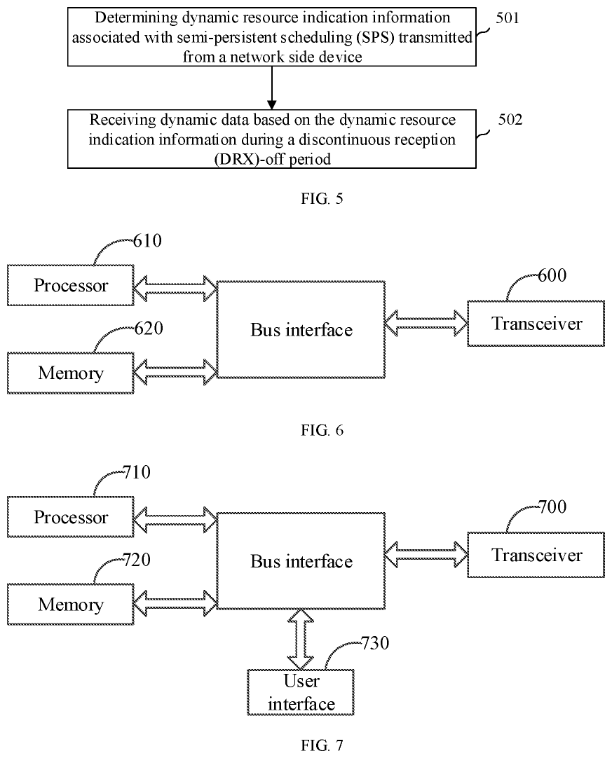

FIG. 5 is a second schematic flowchart of a dynamic data transmission method according to an embodiment of the present application. As shown in FIG. 5, the dynamic data transmission method according to an embodiment of the present application may be applied to a terminal, such as a mobile phone, etc. The dynamic data transmission method includes the following steps.

Step 501: determining dynamic resource indication information associated with semi-persistent scheduling (SPS) transmitted from a network side device.

Step 502: receiving dynamic data based on the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the method further includes the following step:
determining monitoring position information for the DCI signaling.

In an embodiment, the determining the monitoring position information for the DCI signaling includes:
determining a monitoring start time for the DCI signaling; or,
determining a monitoring start time and a duration of a monitoring window for the DCI signaling; or,
determining a monitoring start time and a monitoring end time of a monitoring window for the DCI signaling.

In an embodiment, the method further includes the following step:
receiving a stop indicator transmitted from the network side device, where the stop indicator is configured for indicating the terminal that the network side device stops dynamic data transmission.

The dynamic data transmission method provided by the embodiments of the present application may be completed by referring the above-mentioned dynamic data transmission method embodiment applied to the network-side device, and may achieve the same effect. The corresponding method in this embodiment and the above-mentioned ones is not repeated here. The same parts and beneficial effects of the method embodiments are not described in detail.

FIG. 6 is a schematic structural diagram of a network side device according to an embodiment of the present application. As shown in FIG. 6, the network side device includes a memory 620 storing a computer program, a processor 610 and a transceiver 600 transmitting and receiving data under control of the processor 610,
where the computer program, when executed by the processor 610 of the network side device, causes the network side device to perform the following operations of:
configuring dynamic resource indication information associated with semi-persistent scheduling (SPS) for a terminal; and
indicating dynamic data transmission by using the dynamic resource indication information during a discontinuous reception (DRX)-off period.

In an embodiment, the transceiver 600 is configured for transmitting and receiving data under control of the processor 610.

In FIG. 6, a bus architecture may include any number of interconnected buses and bridges, which are linked together through various circuits of one or more processors represented by processor 610 and one or more memories represented by the memory 620. The bus architecture may also link together various other circuits, such as peripherals, voltage regulators, and power management circuits. The bus interface provides an interface. Transceiver 600 may be multiple elements, i.e., including a transmitter and a receiver, units for providing communication with various other devices over transmission media including wireless channels, wired channels, fiber optic cables, and the like. The processor 610 is responsible for managing the bus architecture and general processing, and the memory 620 may store data used by the processor 610 when performing operations.

The processor 610 may be a central processing unit (CPU), an application specific integrated circuit (ASIC), a field-programmable gate array (FPGA), or a complex programmable logic device (CPLD), the processor may also use a multi-core architecture.

In an embodiment, the dynamic resource indication information is downlink control information (DCI) signaling associated with SPS, and resource allocation information is carried through the DCI signaling.

In an embodiment, the computer program, when executed by the processor of the network side device, causes the network side device to further perform the following operation of:
configuring monitoring position information for the DCI signaling for the terminal.

In an embodiment, the monitoring position information includes one or more of the following information:
monitoring position information semi-statically configured through higher layer signaling; and
monitoring position information dynamically adjusted based on first information.

In an embodiment, in case that the monitoring position information includes the monitoring position information configured semi-statically through the higher layer signaling, the configuring the monitoring position information for the DCI signaling for the terminal includes:
configuring a monitoring start time for the DCI signaling for the terminal; or,
configuring a monitoring start time and a duration of a monitoring window for the DCI signaling for the terminal; or,
configuring a monitoring start time and a monitoring end time of a monitoring window for the DCI signaling for the terminal.

In an embodiment, the duration is determined by one or more of the following:
carrying in L1 signaling;
carrying in a media access control (MAC) layer signaling;
carrying in higher layer signaling; and
a monitoring timer.

In an embodiment, the monitoring position information further includes one or more of the following information:
a time point associated with SPS; and
an independent time point.

In an embodiment, the time point associated with SPS is one or more of the following time points:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.

In an embodiment, a time unit of an offset value of the monitoring position information relative to the time point is a slot, a span, a symbol or millisecond.

In an embodiment, the computer program, when executed by the processor of the network side device, causes the network side device to further perform the following transmitting a dynamic transmission indicator to the terminal, where the dynamic transmission indicator is configured for indicating the terminal that the network side device performs dynamic data transmission.

In an embodiment, the computer program, when executed by the processor of the network side device, causes the network side device to further perform the following operation of:
transmitting a stop indicator to the terminal, where the stop indicator is configured for indicating the terminal that the network side device stops dynamic data transmission.

In an embodiment, the stop indicator is carried through L1 signaling, media access control (MAC) control element (CE) signaling, a power saving signal or higher layer signaling.

In an embodiment, the above-mentioned network side device according to the embodiments of the present application may implement all the method steps implemented by the above-mentioned method embodiments applied to the network side device, and may achieve the same effect. The same parts and beneficial effects as the same method embodiments are not repeated in the present application.

FIG. 7 is a schematic structural diagram of a terminal according to an embodiment of the present application. As shown in FIG. 7, the terminal includes a memory 720 storing a computer program, a processor 710 and a transceiver 700 transmitting and receiving data under control of the processor 710,
where the computer program, when executed by the processor 710 of the terminal, causes the terminal to perform the following operations of:
determining dynamic resource indication information associated with semi-persistent scheduling (SPS) transmitted from a network side device; and
receiving dynamic data based on the dynamic resource indication information during a discontinuous reception (DRX)-off period.

In an embodiment, the transceiver 700 is configured for transmitting and receiving data under control of the processor 710.

In FIG. 7, a bus architecture may include any number of interconnected buses and bridges, which are linked together through various circuits of one or more processors represented by processor 710 and one or more memories represented by the memory 720. The bus architecture may also link together various other circuits, such as peripherals, voltage regulators, and power management circuits. The bus interface provides an interface. The transceiver 700 may be multiple elements, i.e., including a transmitter and a receiver, units for providing communication with various other devices over transmission media including wireless channels, wired channels, fiber optic cables, and the like. For different user equipment, the user interface 730 may also be an interface capable of externally or internally connecting the required equipment, and the connected equipment includes, but not limited to, a keypad, a display, a speaker, a microphone, a joystick, and the like.

The processor 710 is responsible for managing the bus architecture and general processing, and the memory 720 may store data used by the processor 710 when performing operations.

In an embodiment, the processor 710 may be a central processing unit (CPU), an application specific integrated circuit (ASIC), a field-programmable gate array (FPGA), or a complex programmable logic device (CPLD), the processor may also use a multi-core architecture.

The computer program, when executed by the processor, causes the processor to perform any one of the methods of the embodiments of the present application based on the obtained executable instructions by invoking the computer program stored in the memory. The processor and memory may also be physically separated.

In an embodiment, the dynamic resource indication information is downlink control information (DCI) signaling associated with SPS, and resource allocation information is carried through the DCI signaling.

In an embodiment, the computer program, when executed by the processor of the terminal, causes the terminal to further perform the following operation of:
determining monitoring position information for the DCI signaling.

In an embodiment, the determining the monitoring position information for the DCI signaling includes:
determining a monitoring start time for the DCI signaling; or,
determining a monitoring start time and a duration of a monitoring window for the DCI signaling; or,
determining a monitoring start time and a monitoring end time of a monitoring window for the DCI signaling.

In an embodiment, the computer program, when executed by the processor of the terminal, causes the terminal to further perform the following operation of:
receiving a stop indicator transmitted from the network side device, where the stop indicator is configured for indicating the terminal that the network side device stops dynamic data transmission.

It should be noted here that the above-mentioned terminal according to the embodiments of the present application may implement all the method steps implemented by the above-mentioned method embodiments applied to the terminal, and may achieve the same effect. The same parts and beneficial effects as the same method embodiments are not repeated in the present application.

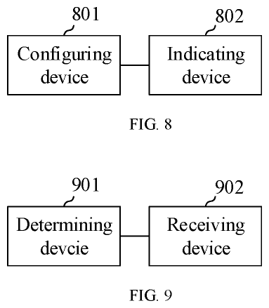

FIG. 8 is a first schematic structural diagram of a dynamic data transmission apparatus according to an embodiment of the present application. As shown in FIG. 8, the dynamic data transmission apparatus according to an embodiment of the present application, including a configuring device 801 and an indicating device 802.

The configuring device 801 is configured for configuring dynamic resource indication information associated with semi-persistent scheduling (SPS) for a terminal; and the indicating device 802 is configured for indicating dynamic data transmission by using the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the dynamic data transmission apparatus further includes a second configuring device,
where the second configuring device is configured for configuring monitoring position information for the DCI signaling for the terminal.

In an embodiment, the monitoring position information includes one or more of the following information:
monitoring position information semi-statically configured through higher layer signaling; and
monitoring position information dynamically adjusted based on first information.

In an embodiment, in case that the monitoring position information includes the monitoring position information configured semi-statically through the higher layer signaling, the second configuring device includes a first configuring sub-device, a second configuring sub-device and a third configuring sub-device,
where the first configuring sub-device is configured for configuring a monitoring start time for the DCI signaling for the terminal;
the second configuring sub-device is configured for configuring a monitoring start time and a duration of a monitoring window for the DCI signaling for the terminal; and
the third configuring sub-device is configured for configuring a monitoring start time and a monitoring end time of a monitoring window for the DCI signaling for the terminal.

In an embodiment, the duration is determined by one or more of the following:
carrying in L1 signaling;
carrying in a media access control (MAC) layer signaling;
carrying in higher layer signaling; and
a monitoring timer.

In an embodiment, the monitoring position information further includes one or more of the following information:
a time point associated with SPS; and
an independent time point.

In an embodiment, the time point associated with SPS is one or more of the following time points:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.

In an embodiment, a time unit of an offset value of the monitoring position information relative to the time point is a slot, a span, a symbol or millisecond.

In an embodiment, the dynamic data transmission apparatus further includes a first indicating device,
where the first indicating device is configured for transmitting a dynamic transmission indicator to the terminal, where the dynamic transmission indicator is configured for indicating the terminal that the network side device performs dynamic data transmission.

In an embodiment, the dynamic data transmission apparatus further includes a second indicating device,
where the second indicating device is configured for transmitting a stop indicator to the terminal, where the stop indicator is configured for indicating the terminal that the network side device stops dynamic data transmission.

In an embodiment, the stop indicator is carried through L1 signaling, media access control (MAC) control element (CE) signaling, a power saving signal or higher layer signaling.

In an embodiment, the above-mentioned dynamic data transmission apparatus according to the embodiments of the present application may implement all the method steps implemented by the above-mentioned method embodiments applied to the network side device, and may achieve the same effect. The same parts and beneficial effects as the same method embodiments are not repeated in the present application.

FIG. 9 is a second schematic structural diagram of a dynamic data transmission apparatus according to an embodiment of the present application. As shown in FIG. 9, the dynamic data transmission apparatus according to an embodiment of the present application, including a determining device 901 and a receiving device 902.

The determining device 901 is configured for determining dynamic resource indication information associated with semi-persistent scheduling (SPS) transmitted from a network side device; and the receiving device 902 is configured for receiving dynamic data based on the dynamic resource indication information during a discontinuous reception (DRX)-off period.

In an embodiment, the dynamic resource indication information is downlink control information (DCI) signaling associated with SPS, and resource allocation information is carried through the DCI signaling.

In an embodiment, the dynamic data transmission apparatus further includes a second determining device,
where the second determining device is configured for determining monitoring position information for the DCI signaling.

In an embodiment, the second determining device includes a first determining sub-device, a second determining sub-device and a third determining sub-device,
where the first determining sub-device is configured for determining a monitoring start time for the DCI signaling;
the second determining sub-device is configured for determining a monitoring start time and a duration of a monitoring window for the DCI signaling; and
the third determining sub-device is configured for determining a monitoring start time and a monitoring end time of a monitoring window for the DCI signaling.

In an embodiment, the dynamic data transmission apparatus further includes a second receiving device,
where the second receiving device is configured for receiving a stop indicator transmitted from the network side device, where the stop indicator is configured for indicating the terminal that the network side device stops dynamic data transmission.

In an embodiment, the above-mentioned dynamic data transmission apparatus according to the embodiments of the present application may implement all the method steps implemented by the above-mentioned method embodiments applied to the terminal, and may achieve the same effect. The same parts and beneficial effects as the same method embodiments are not repeated in the present application.

It should be noted that, the division of units/devices in the embodiments of the present application is schematic, and is only a logical function division, and there may be other division manners in actual implementation. In addition, the functional units in the various embodiments of the present application may be integrated into one processing unit, or each unit may exist alone physically, or two or more units may be integrated into one unit. The above-mentioned integrated unit may be implemented in the form of hardware or software functional unit.

If the integrated unit is implemented in the form of a software functional unit and sold or used as an independent product, it may be stored in a computer readable storage medium. Based on such understanding, the embodiments of the present application in essence or a part of the embodiments that contributes to the related art, or all or part of the embodiments, may be embodied in the form of a software product, which is stored in a storage medium, including several instructions to cause a computer device (which may be a personal computer, server, or network device, etc.) or a processor to perform all or part of the steps of the methods described in the respective embodiments of the present application. The storage medium described above includes various media that may store program codes such as U disk, mobile hard disk, read-only memory (ROM), random access memory (RAM), magnetic disk, or optical disk.

An embodiment of the present application provides a processor-readable storage medium storing a computer program that, when executed by a processor, causes the processor to perform the steps of the methods described above, including:
configuring dynamic resource indication information associated with semi-persistent scheduling (SPS) for a terminal; and indicating dynamic data transmission by using the dynamic resource indication information during a discontinuous reception (DRX)-off period;
or,
determining dynamic resource indication information associated with semi-persistent scheduling (SPS) transmitted from a network side device; and receiving dynamic data based on the dynamic resource indication information during a discontinuous reception (DRX)-off period.

It should be noted that the processor-readable storage medium may be any available medium or data storage device that may be accessed by the processor, including but not limited to, a magnetic storage (e.g., a floppy disk, a hard disk, a magnetic tape, a magneto-optical disk (MO), etc.), optical memory (such as CD, DVD, BD, HVD, etc.), and a semiconductor memory (such as ROM, EPROM, EEPROM, non-volatile memory (NAND FLASH), solid-state drive (SSD)), etc.

In should be noted that terms “first”, “second”, etc., are used to distinguish similar objects and are not used to describe a particular order or sequence. It should be noted that these terms are interchangeable under appropriate circumstances and embodiments of the present application may be practiced in sequences other than those illustrated or described herein, and the objects distinguished by “first” and “second” have the same type, and the number of the objects is not limited. For example, the first object may be one or multiple.

In the embodiments of the present application, the term “and/or” describes a related relationship of associated objects, and indicates that there may be three kinds of relationships. For example, A and/or B may represent that A exists alone, A and B exist simultaneously, and B exists alone. Character “/” generally indicates that the associated objects have an “or” relationship.

In the embodiments of the present application, the term “multiple” refers to two or more than two, and other quantifiers are similar.

The solutions according to the embodiments of the present application may be applicable to various systems, especially 5G systems. For example, applicable systems may be a global system of mobile communication (GSM) system, a code division multiple access (CDMA) system, a wideband code division multiple access (WCDMA) general packet radio service (GPRS) system, a long term evolution (LTE) system, a LTE frequency division duplex (FDD) system, a LTE time division duplex (TDD) system, a long term evolution advanced (LTE-A) system, a universal mobile telecommunication system (UMTS), a worldwide interoperability for microwave access (WiMAX) system, a 5G new radio (NR) system, etc. These various systems include a user equipment and a network side device. The system may also include a core network part, such as an evolved packet system (EPS), a 5G system (5GS), and the like.

The terminal in the embodiments of the present application may be a device that provides voice and/or data connectivity to a user, a handheld device with a radio connection function, or other processing device connected to a radio modem. In different systems, the names of the terminal may be different. For example, in the 5G system, the terminal may be called as user equipment (UE). A radio terminal may communicate with one or more core networks (CN) via a radio access network (RAN), and the radio terminal may be a mobile terminal, such as a mobile phone (or “cellular” phone) and computers with mobile terminal, e.g., a portable mobile device, a pocket-sized mobile device, a hand-held mobile device, a computer-built mobile device or a vehicle-mounted mobile device, which exchange language and/or data with the radio access network. For example, a personal communication service (PCS) phone, a radio phone, a session initiated protocol (SIP) phone, a wireless local loop (WLL) station, a personal digital assistant (PDA) and other devices. A radio terminal may also be called a system, a subscriber unit, a subscriber station, a mobile station, a mobile, a remote station, an access point, a remote terminal, an access terminal, a user terminal, a user agent, and a user device, which are not limited in the embodiments of the present application.

The network side device in the embodiments of the present application may be a base station, and the base station may include multiple cells providing services for the terminal. Depending on the specific application, the network side device may also be called an access point, or may be a device in the access network that communicates with radio terminal through one or more sectors on the air interface, or other names. Network device may be used to exchange received air frames with internet protocol (IP) packets, and act as a router between radio terminal and the rest of the access network, and the rest of the access network may include an IP communication network. The network side device may also coordinate attribute management for the air interface. For example, the network device in the embodiments of the present application may be a base transceiver station (BTS) in a global system for mobile communications (GSM) or a code division multiple access (CDMA), may also be a node B in a wide-band code division multiple access (WCDMA), may also be an evolutional node B (eNB or e-Node B) in a long term evolution (LTE) system, a 5G base station (gNB) in 5G network architecture (next generation system), may also be a Home evolved Node B (HeNB), a relay node (relay node), a femto, a pico base station (pico), etc., which are not limited in the embodiments of the present application. In some network structures, a network device may include a centralized unit (CU) node and a distributed unit (DU) node, and the centralized unit and the distributed unit may also be geographically separated.

Multi-input multi-output (MIMO) transmission may be performed between the network device and the terminal using one or more antennas and the MIMO transmission may be single user MIMO (SU-MIMO) or multiple user MIMO (MU-MIMO). According to the form and number of antenna combinations, MIMO transmission may be 2D-MIMO, 3D-MIMO, FD-MIMO, or massive-MIMO, and may also be diversity transmission, precoding transmission, or beamforming transmission.

Embodiments of the present application may be provided as a method, system, or computer program product. Accordingly, the present application may take the form of an entirely hardware embodiment, an entirely software embodiment, or an embodiment combining software and hardware aspects. Furthermore, the present application may take the form of a computer program product embodied on one or more computer-usable storage media having computer-usable program code embodied therein, including but not limited to disk storage, optical storage, and the like.

The present application is described with reference to flow charts and/or block diagrams of methods, apparatus (systems), and computer program products according to embodiments of the present application. It will be understood that each flow and/or block in the flow charts and/or block diagrams, and combinations thereof may be implemented by computer-executable instructions. These computer-executable instructions may be provided to processors of a general purpose computer, a special purpose computer, an embedded processor or other programmable data processing device to produce a machine and the instructions executed by the processor of the computer or other programmable data processing device form a means for performing the functions specified in one or more flows in a flowchart and/or one or more blocks of a block diagram.

These processor-executable instructions may also be stored in a processor-readable memory capable of directing a computer or other programmable data processing apparatus to operate in a particular manner, and the instructions stored in the processor-readable memory may result in a manufacture including instruction means, the instruction means may perform the functions specified in one or more flows of the flowchart and/or one or more blocks of the block diagram.

These processor-executable instructions may also be loaded onto a computer or other programmable data processing device to cause a series of operational steps to be performed on the computer or other programmable device to produce a computer-implemented process and instructions performed on the computer or other programmable devices provide steps for performing the functions specified in one or more flows of the flowchart and/or one or more blocks of the block diagram.

Various modifications and variations may be made to the present application without departing from the scope of the present application. Thus, provided that these modifications and variations of the present application fall within the scope of the claims of the present application and their equivalents, the present application is also intended to cover such modifications and variations.

1. A dynamic data transmission method, applied to a terminal, comprising:
determining dynamic resource indication information associated with semi-persistent scheduling (SPS) transmitted from a network side device; and
receiving dynamic data based on the dynamic resource indication information during a discontinuous reception (DRX)-off period.

2. The method of claim 1, wherein the dynamic resource indication information is downlink control information (DCI) signaling associated with SPS, and resource allocation information is carried through the DCI signaling.

3. The method of claim 2, further comprising:
determining monitoring position information for the DCI signaling.
wherein determining the monitoring position information for the DCI signaling comprises:
determining a monitoring start time for the DCI signaling; or,
determining a monitoring start time and a duration of a monitoring window for the DCI signaling; or,
determining a monitoring start time and a monitoring end time of a monitoring window for the DCI signaling.

4. (canceled)

5. The method of claim 1, further comprising:
receiving a stop indicator transmitted from the network side device, wherein the stop indicator is configured for indicating the terminal that the network side device stops dynamic data transmission.

6. A dynamic data transmission method, applied to a network side device, comprising:
configuring dynamic resource indication information associated with semi-persistent scheduling (SPS) for a terminal; and
indicating dynamic data transmission by using the dynamic resource indication information during a discontinuous reception (DRX)-off period.

7. The method of claim 6, wherein the dynamic resource indication information is downlink control information (DCI) signaling associated with SPS, and resource allocation information is carried through the DCI signaling.

8. The method of claim 7, further comprising:
configuring monitoring position information for the DCI signaling for the terminal,
wherein the monitoring position information comprises one or more of the following information:
monitoring position information semi-statically configured through higher layer signaling; and
monitoring position information dynamically adjusted based on first information;
wherein in case that the monitoring position information comprises the monitoring position information configured semi-statically through the higher layer signaling. the configuring the monitoring position information for the DCI signaling for the terminal comprises:
configuring a monitoring start time for the DCI signaling for the terminal; or,
configuring a monitoring start time and a duration of a monitoring window for the DCI signaling for the terminal; or,
configuring a monitoring start time and a monitoring end time of a monitoring window for the DCI signaling for the terminal,
wherein the duration is determined by one or more of the following:
carrying in L1 signaling;
carrying in a media access control (MAC) layer signaling;
carrying in higher layer signaling; and
a monitoring timer.

9-11. (canceled)

12. The method of claim 8, wherein the monitoring position information further comprises one or more of the following information:
a time point associated with SPS; and
an independent time point,
wherein the time point associated with SPS is one or more of the following:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer,
wherein a time unit of an offset value of the monitoring position information relative to the time point is a slot, a span, a symbol or millisecond.

13-14. (canceled)

15. The method of claim 6, further comprising:
transmitting a dynamic transmission indicator to the terminal, wherein the dynamic transmission indicator is configured for indicating the terminal that the network side device performs dynamic data transmission.

16. The method of claim 6, further comprising:
transmitting a stop indicator to the terminal, wherein the stop indicator is configured for indicating the terminal that the network side device stops dynamic data transmission,
wherein the stop indicator is carried through L1 signaling, media access control (MAC) control element (CE) signaling, a power saving signal or higher layer signaling.

17. (canceled)

18. A network side device, comprising a memory storing a computer program, a processor, a transceiver for transmitting and receiving data under control of the processor,
where the computer program, when executed by the processor of the network side device, causes the network side device to perform the following operations of:
configuring dynamic resource indication information associated with semi-persistent scheduling (SPS) for a terminal; and
indicating dynamic data transmission by using the dynamic resource indication information during a discontinuous reception (DRX)-off period.

19. The network side device of claim 18, wherein the dynamic resource indication information is downlink control information (DCI) signaling associated with SPS, and resource allocation information is carried through the DCI signaling.

20. The network side device of claim 19, wherein the computer program, when executed by the processor of the network side device, causes the network side device to further perform the following operation:
configuring monitoring position information for the DCI signaling for the terminal,
wherein the monitoring position information comprises one or more of the following information:
monitoring position information semi-statically configured through higher layer signaling; and
monitoring position information dynamically adjusted based on first information,
wherein in case that the monitoring position information comprises the monitoring position information configured semi-statically through the higher layer signaling, configuring the monitoring position information for the DCI signaling for the terminal comprises:
configuring a monitoring start time for the DCI signaling for the terminal; or,
configuring a monitoring start time and a duration of a monitoring window for the DCI signaling for the terminal; or,
configuring a monitoring start time and a monitoring end time of a monitoring window for the DCI signaling for the terminal,
wherein the duration is determined by one or more of the following:
carrying in L1 signaling;
carrying in a media access control (MAC) layer signaling;
carrying in higher layer signaling; and
a monitoring timer.

21-23. (canceled)

24. The network side device of claim 20, wherein the monitoring position information further comprises one or more of the following information:
a time point associated with SPS; and
an independent time point,
wherein the time point associated with SPS is one or more of the following:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer,
wherein a time unit of an offset value of the monitoring position information relative to the time point is a slot, a span, a symbol or millisecond.

25-26. (canceled)

27. The network side device of claim 18, wherein the computer program, when executed by the processor of the network side device, causes the network side device to further perform the following operation of:
transmitting a dynamic transmission indicator to the terminal, wherein the dynamic transmission indicator is configured for indicating the terminal that the network side device performs dynamic data transmission.

28. The network side device of claim 18, wherein the computer program, when executed by the processor of the network side device, causes the network side device to further perform the following operation of:
transmitting a stop indicator to the terminal, wherein the stop indicator is configured for indicating the terminal that the network side device stops dynamic data transmission, wherein the stop indicator is carried through L1 signaling, media access control (MAC) control element (CE) signaling, a power saving signal or higher layer signaling.

29. (canceled)

30. A terminal, comprising a memory storing a computer program, a processor, and a transceiver receiving and transmitting data under control of the processor,
where the computer program, when executed by the processor of the terminal, causes the terminal to perform the method of claim 1.

31. The terminal of claim 30, wherein the dynamic resource indication information is downlink control information (DCI) signaling associated with SPS, and resource allocation information is carried through the DCI signaling.

32. The terminal of claim 31, wherein the computer program, when executed by the processor of the terminal, causes the terminal to further perform the following operation of:
determining monitoring position information for the DCI signaling,
wherein the determining the monitoring position information for the DCI signaling comprises:
determining a monitoring start time for the DCI signaling; or,
determining a monitoring start time and a duration of a monitoring window for the DCI signaling; or,
determining a monitoring start time and a monitoring end time of a monitoring window for the DCI signaling.

33. (canceled)

34. The terminal of claim 30, wherein the computer program, when executed by the processor of the terminal, causes the terminal to further perform the following operation of:
receiving a stop indicator transmitted from the network side device, wherein the stop indicator is configured for indicating the terminal that the network side device stops dynamic data transmission.

35-52. (canceled)

53. The method of claim 3, wherein the monitoring position information further comprises one or more of the following information:
a time point associated with SPS; and
an independent time point,
wherein the time point associated with SPS is one or more of the following:
a time point associated with an SPS physical downlink shared channel (PDSCH);
a time point associated with a hybrid automatic repeat request (HARQ)-acknowledge (ACK) for an SPS PDSCH; and
a time point associated with expiring of an SPS PDSCH round trip time (RTT) timer.
